(19) United States
(12) Patent Application Publication
(10) Pub. No.: US 2003/0033610 A1
(43) Pub. Date: Feb. 13, 2003

(54) Broadcast program recorder, computer program, and recorded medium

(76) Inventor: Sunao Takatori, Tokyo (JP)

Correspondence Address: DARBY & DARBY P.C., P. O. BOX 5257, NEW YORK, NY, 10150-5257, US

(21) Appl. No.: 10/220,959

(22) PCT Filed: Mar. 1, 2001
(86) PCT No.: PCT/JP01/01591

(30) Foreign Application Priority Data
Mar. 6, 2000 (JP) 2000-060792

(51) Int. Cl. H04N 9/00; H04N 11/00; H04N 5/91; H04N 7/00; H04N 7/173; H04N 7/16

(52) U.S. Cl. 725/133; 725/141; 725/153; 386/1; 386/46

(57) ABSTRACT

A subject is to record a program by directly using a TV program schedule obtained through information networks such as the Internet. A program video recording apparatus of the present invention comprises a transmission/reception section (9) for establishing a communication line with an information provider, a TV set (1) for displaying TV program information provided by the information provider, and a control section (7) for instructing a recording reservation for a program in accordance with program designation from the TV program information displayed on the TV set (1).

### TECHNICAL FIELD

The present invention relates to a program video recording apparatus, in particular to a program video recording apparatus, a computer program, and a recording medium for recording TV programs by using a TV program schedule obtained through information networks such as the Internet.

### BACKGROUND ART

With the diffusion of information networks such as the Internet, a user can obtain various kinds of information if he needs them.

As the Internet becomes widespread, means to be used by a user for accessing information networks are personal computers and mobile communication terminals, and they are expected to be further extended to household electronic apparatus.

### DISCLOSURE OF THE INVENTION

It is highly probable that in the future, most electronic apparatus will be able to directly obtain information relevant to the electronic apparatus themselves through the Internet. In this case, there will be a demand that operations to obtain information and operations of the electronic apparatuses using the obtained information should be simpler and easier for users.

For example, in the case of recording a TV program by using a TV program schedule provided through information networks, e.g. the Internet, a user is required to make interactions with a plurality of different objects, such as connecting to the Internet, obtaining the TV program schedule, making a recording reservation and the like. Further, in such a case, since the objects to be directly operated change, such as from a mobile communication terminal to a remote controller for recording, the user has to appropriately select and use these objects to be operated.

The object of the present invention is to provide a program video recording apparatus, a computer program, and a recording medium which are capable of recording TV programs by the use of a TV program schedule obtained from information networks, e.g. the Internet.

In order to accomplish the above object, the program video recording apparatus of the present invention comprises line-establishing means for establishing a communication line with an information provider, display means for displaying program information provided by the information provider, and instruction means for instructing a recording reservation for a TV program in accordance with program designation from the program information displayed on the display means.

In addition, the program video recording apparatus further comprises receiving means for receiving specific information pertinent to a subscriber line, wherein the line-establishing means establishes the communication line with the information provider based on the specific information received by the receiving means, and therefore, for example, when a subscriber line of, e.g. a mobile communication terminal is established, the terminal can be regarded as an object to be charged for line usage. Moreover, when the terminal has a function of a remote controller for recording reservations, processes from line-establishing to program recording are carried out by operating one terminal.

In another aspect, the present invention is a computer program allowing a computer to function as a program video recording apparatus, the program video recording apparatus comprising: line-establishing means for establishing a communication line with an information provider; display means for displaying program information provided by the information provider; and instruction means for instructing a recording reservation for a program in accordance with program designation from the program information displayed on the display means.

In another aspect, the present invention is a computer readable recording medium having a computer program recorded therein, wherein the program allows a computer to function as a program video recording apparatus, the program video recording apparatus comprising: line-establishing means for establishing a communication line with an information provider; display means for displaying program information provided by the information provider; and instruction means for instructing a recording reservation for a program in accordance with program designation from the program information displayed on the display means.

This specification contains part or all of the contents described in the specification and/or drawings of Japanese Patent Application No. 2000-60792, on which the priority is claimed.

### BRIEF DESCRIPTION OF THE DRAWINGS

FIG. 1 is a view illustrating a concept of a video recording system including a program video recording apparatus according to an embodiment of the present invention.

FIG. 2 is a block diagram illustrating a configuration of a communication device according to the present embodiment.

FIG. 3 is a functional block diagram illustrating functions of the communication device according to the present embodiment.

FIG. 4 is a view exemplifying a history table.

FIG. 5 is a view exemplifying a user authentication format between the communication device (program video recording apparatus) and the mobile communication terminal according to the present embodiment.

FIG. 6 is a flow chart illustrating operations of the communication ice according to the present embodiment of the present invention.

### EXPLANATION OF THE REFERENCE SYMBOLS

1 TV

3 Communication device

5 Mobile communication terminal

6 the Internet

7 Control section

9 Transmission/reception section

11 RAM

13 History table

15 ROM

17 Input operation section

19 Display section

21 Recording request detection function

23 Line establishing function

25 Program schedule acquisition function

27 Recording reservation control function

29 Recording/playback monitor function

31, 33 Label tag

### BEST MODE FOR CARRYING OUT THE INVENTION

Preferable embodiments of the present invention will hereinafter be described in detail by referring to the accompanying drawings.

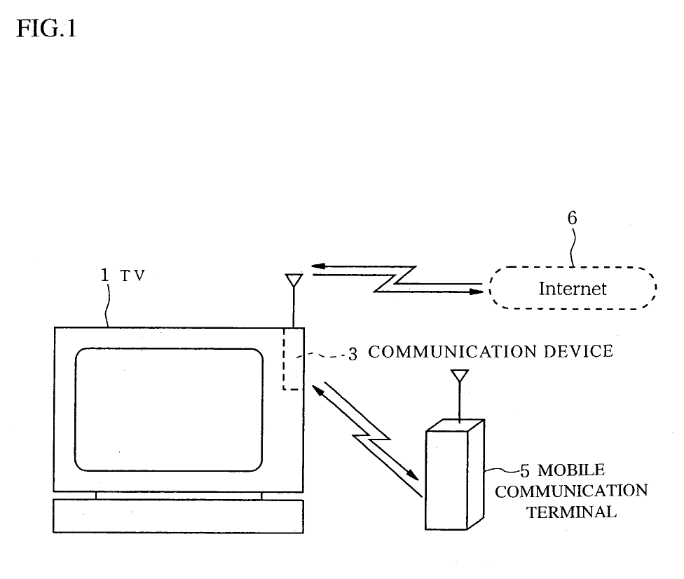

FIG. 1 is a block diagram illustrating a concept of a recording system which includes a program video recording apparatus according to an embodiment of the present invention. This recording system is composed of a program video recording apparatus comprising a television set (TV) 1 and a communication device 3, a mobile communication terminal 5, and an information provider such as the Internet 6.

Herein, the communication device 3 constituting the program video recording apparatus will be described. The communication device 3 is integrally configured to the TV 1 which receives and records a designated TV program.

The communication device 3, for example as shown in FIG. 1, is embedded inside a housing of the TV 1 and electrically connected with a circuit which implements the function of the TV 1 itself, or it is electrically connected with the circuit which implements the function of the TV 1 so as to be integrated therewith through an interface section (not shown) such as a connector (and a plug socket). Alternatively, it is spatially separated from the TV 1 but is electrically or electro-magnetically connected through a wired or wireless line with the circuit which implements the functions of the TV 1 so as to be integrated with the TV 1.

The mobile communication terminal 5 issues a request for recording a TV program to the communication device 3, and also performs a recording reservation operation for a predetermined TV program as a remote controller of the TV 1 for recording.

The mobile communication terminal 5 transmits specific information to the communication device 3 when the TV program is recorded on the TV 1. This specific information is related to a subscriber line assigned to the mobile communication terminal 5, and in the present embodiment, an ID is used as this specific information. Further, the mobile communication terminal 5 selects and makes a recording reservation for a TV program when TV program information obtained through the Internet 6 is displayed on the TV 1.

The communication device 3 performs data communications among a predetermined site on the Internet 6 which provides the TV program information, the TV 1 and the mobile communication terminal 5.

When the communication device 3 detects a transmitted ID, it recognizes a request for recording from a mobile communication terminal 5 having that ID. The format of client authentication using the request for recording (ID) will be described below. Further, among predetermined sites on the Internet 6, TV program information is obtained by using the subscriber line of the mobile communication terminal 5. Display control etc. of the obtained TV program information is carried out with the TV 1. Recording reservation control described below is carried out with the mobile communication terminal 5 in accordance with the operations of recording reservation on the TV program information displayed on the TV 1.

The TV 1 is a digital television set in the present embodiment, and it is internally or externally provided with storage means and recording means (not shown). The TV 1 performs a recording process based on the operations of recording reservation from the mobile communication terminal 5.

The TV 1 displays the TV program information obtained through the Internet 6 in accordance with the control of the communication device 3. The recording means records the predetermined TV program on the storage means such as a hard disk device based on the recording reservation operation from the mobile communication terminal 5 (communication device 3).

The Internet 6 accommodates information servers (not shown) which provide TV program information prepared by information providers such as an individual or a company. Incidentally, when an information providing fee is generated for the TV program information obtained from the predetermined site on the Internet 6, the mobile communication terminal 5 is regarded as an object to be charged, and the information providing fee is added to the usage fee (toll) of the subscriber line of the terminal 5.

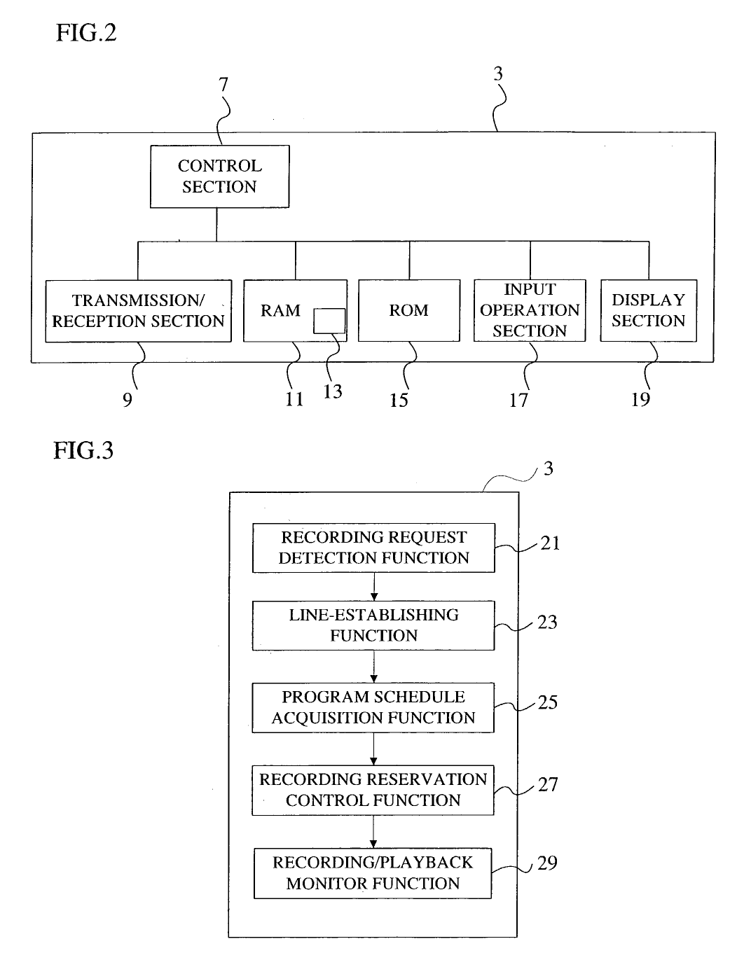

FIG. 2 is a block diagram illustrating the configuration of the communication device 3 according to the present embodiment. The communication device 3 comprises a control section 7, a transmission/reception section 9, a RAM 11, a ROM 15, an input operation section 17, and a display section 19.

The control section 7 is a CPU, and it controls operations of the whole communication device 3. In particular, it performs communication control of the transmission/reception section 9, storage control of the RAM 11 and display control of the TV 1 for the TV program information obtained through the Internet 6, recording reservation control on the TV 1 (recording means), monitoring of recording/playback, and the like.

The transmission/reception section 9 performs transmission or reception process among the mobile communication terminal 5, the Internet 6, or the TV 1, based on the instructions of the control section 7. In particular, it performs a reception process of requests for recording (ID) from the mobile communication terminal 5, a line connection process to a predetermined site on the Internet 6, a reception process of the TV program information, etc.

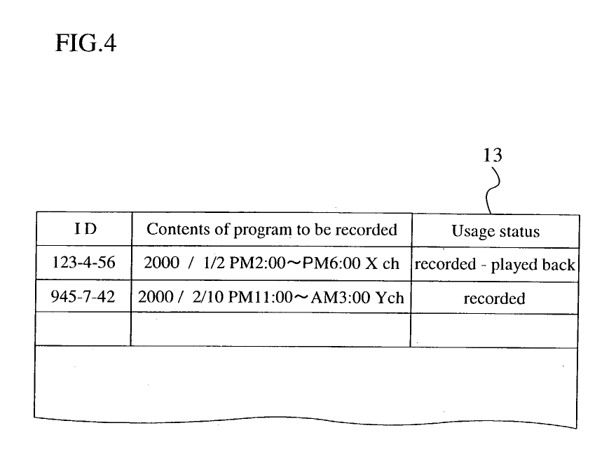

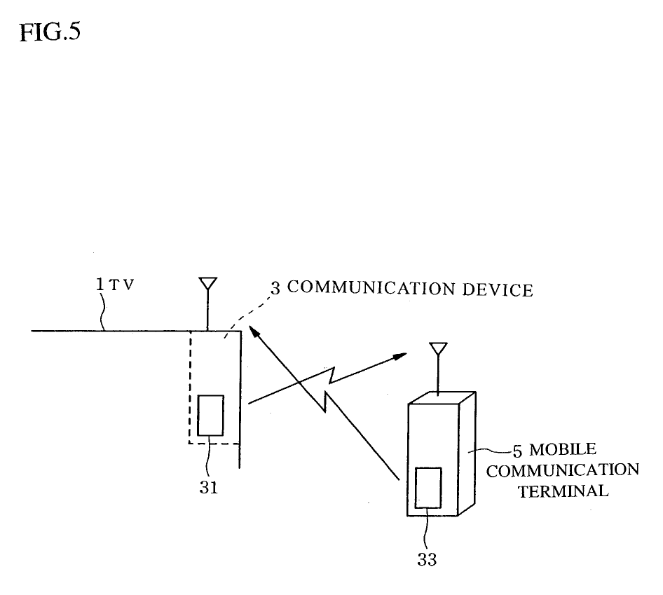

The RAM 11 temporarily stores data necessary for processes of the communication device 3. In particular, it stores the TV program information and a history table 13 (see FIG. 4) for storing a recording history of the TV 1.

The ROM 15 fixedly stores a computer program for instructing the operations of the communication device 3. The input operation section 17 is an input key, etc. and used for input operations when updating the history table 13, etc. The display section 19 is an LCD, etc. and it converts code data to display data each time based on the instructions of the control section 7, and then displays the history table 13, etc.

FIG. 4 is a view exemplifying the history table 13. In this history table 13, contents of a program to be recorded (date, time period of recording, channel and so on) and its usage statuses (recording status, reproduction status, and so on) are stored corresponding to an ID of the mobile communication terminal.

For example, the example of FIG. 4 shows that a user with ID “123-4-56” made a recording reservation for a program on channel “X” during the time period “from PM 2:00 to PM 6:00” on the date of “2000/1/2,” and the usage status indicates “recording completed” and further “playback completed.”Similarly, another user with ID “945-7-42” made a recording reservation for a program on channel “Y” during the time period from “PM 11:00” of the date “2000/2/10” to “AM 3:00” of the next day. According to the usage status, it is stored that “recording has been completed” but the recorded program has not yet been played back.

Whenever many users make recording reservations on the TV 1, this history table 13 allows users to check the remaining capacity of the storage means of the TV 1, thereby preventing a failure of recording. For instance, when the recording reservation operation is carried out from the mobile communication terminal 5, the control section 7 commands the mobile communication terminal 5 to secure a storage capacity based on the remaining capacity and the reserved recording period.

FIG. 3 is a functional block diagram illustrating functions of the communication device 3 according to the present embodiment. The communication device 3 comprises a recording request detection function 21, a line-establishing function 23, a program schedule acquisition function 25, a recording reservation control function 27, and a recording/playback monitor function 29. These functions are performed based on the instructions of the control section 7 shown in FIG. 2.

With respect to the recording request detection function 21, the control section 7 controls the transmission/reception section 9 to detect an ID transmitted from the mobile communication terminal 5, thereby recognizing a request for recording a TV program. The transmission/reception section 9 receives the ID from the mobile communication terminal 5 and the received ID is registered in the history table 13 by the control section 7. Here, the format of authentication of users by ID is briefly explained.

FIG. 5 is a view exemplifying a format of user authentication between the communication device 3 (program video recording apparatus) and the mobile communication terminal 5 according to the present embodiment. As shown in FIG. 5, the communication device 3 is provided with a label tag 31 which generates a signal specific to the communication device 3, and the mobile communication terminal 5 is provided with a label tag 33 which generates a signal specific to the terminal 5. The operations of the label tag 31 in generating the specific signal is independent from the communication device 3, and the operations of the label tag 33 in generating the specific signal is independent from the mobile communication terminal 5.

Each of the label tags 31 and 33 comprises an IC (Integrated Circuit) and an interface such as a Bluetooth connector, and plays a role of a non-contact sensor. These mutually generate signals which differ from a signal transmitted on the general subscriber line to recognize each other.

The specific signal generated by the label tag 33 is detected by the transmission/reception section 9 (see FIG. 2) of the communication device 3, and the specific signal generated by the label tag 31 is detected by a reception section (not shown) of the mobile communication terminal 5. When both mutually detect each other, user authentication is carried out for a request for recording a TV program and an ID is transmitted from the mobile communication terminal 5. This allows the communication device 3 to detect the ID of the mobile communication terminal 5 and to give permission for an owner of the terminal 5 to use the TV 1 for recording reservation, playback, etc.

Next, with respect to the line-establishing function 23 and the program schedule acquisition function 25 (see FIG. 3), the control section 7 establishes a line to a designated site on the Internet 6, and displays TV program information on the TV 1. The control section 7 controls the transmission/reception section 9 to connect with the Internet 6 and also performs display control on TV 1. At this time, the transmission/reception section 9 establishes communication line to the Internet 6 by using the subscriber line based on the ID received in advance. Further, the communication line is updated in accordance with a site designation from the mobile communication terminal 5.

For example, by the format shown in FIG. 5, or the like, in accordance with the site designation from the mobile communication terminal 5, the transmission/reception section 9 updates the line connection by transmitting the designated site to an information server (not shown) on the Internet 6 or the like. Further, along with this site change, the transmission/reception section 9 receives the display data for each site transmitted from the Internet 6 each time. Then, the control section 7 stores the received display data temporarily in the RAM 11, etc., and also controls the TV 1 to display the display data. As described above, the TV program information provided on the designated site of the Internet 6 is displayed on the TV 1.

Next, with respect to the recording reservation control function 27, the control section 7 controls the recording means of the TV 1 in response to the recording reservation operation from the mobile communication terminal 5. For example, by the format shown in FIG. 5, etc., the mobile communication terminal 5 designates a program to be recorded from the TV program information displayed on the TV 1.

In this case, a user designates the program to be recorded by using a jog dial, etc. provided in the mobile communication terminal 5, and the designated program to be recorded is color-coded within its frame. Thereby, the user can identify the content of the designated program to be recorded on a display screen.

As described above, the control section 7 displays the contents of the history table 13 on the TV 1, based on the recording time period of the designated program to be recorded and the remaining capacity of the storage means of the TV 1. Also, the control section 7 instructs the mobile communication terminal 5 to secure storage capacity.

The control section 7 obtains data (date, recording time period, channel etc.) for the designated program to be recorded from the TV program information stored in the RAM 11, and registers it into the history table 13 as the content of a program to be recorded, then transmitting the data for the program to the recording means of the TV 1. By this, the recording means of the TV 1 records the program to be recorded on the storage means when the predetermined time has come.

Next, with respect to the recording/playback monitor function 29, the control section 7 monitors the recording process which is carried out at the predetermined recording time and the playback process for the recorded program, and the control section 7 updates the usage status of the history table 13,each time.

With respect to the above program schedule acquisition function 25 and recording reservation control function 27, the communication device 3 performs switching of its role from an interface between the mobile communication terminal 5 and the Internet 6 to an interface between the mobile communication terminal 5 and the TV 1 each time.

What the user has to do is simply to look at the content displayed on the TV 1 and to operate the terminal 5 which also has the function of a remote controller for recording. According to the foregoing, recording reservation operations can be executed by directly using the TV program information provided on the designated site of the Internet 6.

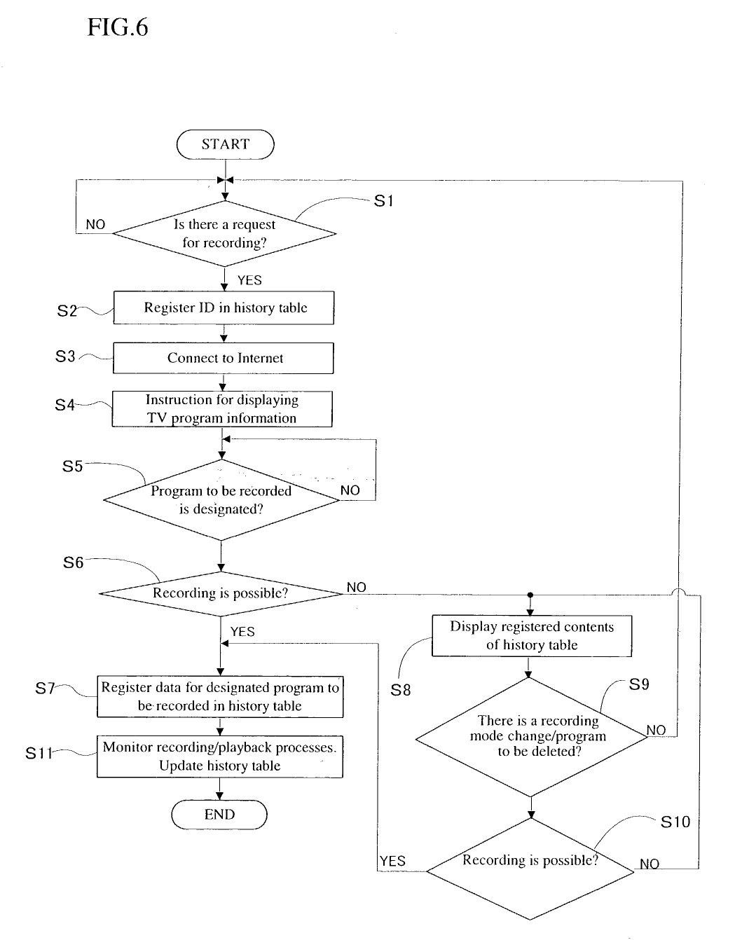

FIG. 6 is a flowchart illustrating the operations of the communication device 3 according to the present embodiment. Here, the operations of the communication device 3 will mainly be described.

First, in Step S1, it is judged whether or not there is a request for recording a TV program from the mobile communication terminal 5. In particular, the mobile communication terminal 5 and the communication device 3 detect specific signals each other within a predetermined distance therebetween, and thereafter an ID is received from the mobile communication terminal 5.

By this, the communication device 3 within the predetermined distance from the mobile communication terminal 5 can detect the ID, but a communication device (not shown) provided in other TVs outside the predetermined distance cannot detect the ID. Therefore, only TV 1 which the user intends to use for recording and playing back the program is allowed to obtain the TV program information.

When the request for recording is detected in Step S1, the received ID is registered in the history table 13 in Step S2. However, if the request for recording is not detected, the state of Step S1 is maintained.

Next, in Step S3, the communication line to the Internet 6 is established by using a subscriber line of the mobile communication terminal 5. Subsequently, in Step S4, the TV program information provided on the designated site is displayed on the TV 1, then proceeding to Step S5.

In Step S5, it is judged whether or not a program to be recorded is designated from the mobile communication terminal 5. When the program to be recorded is designated, in Step S6, it is judged whether or not recording of the program is possible, based on the remaining capacity of the storage means of the TV 1, the recording time period for the designated program to be recorded, and other recording reservations. However, if no programs to be recorded are designated in Step S5, the state of Step S5 is maintained.

In Step S6, when it is judged that the recording is possible, the data (date, time period of recording, channel and so on) of the designated program to be recorded is transmitted to the recording means of the TV 1 and also registered into the history table 13 in Step S7.

Further, when it is judged that the recording is not possible, the registered contents of the history table 13 is displayed on the TV 1 in Step S8, and in Step S9, the user is recommended to change the recording mode of the reserved TV program or select a recorded program to be deleted from the storage means of the TV 1.

In Step S9, when the user's instruction to change the recording mode or to select a recorded program to be deleted is obtained, it is judged, in Step S10, whether or not the recording is possible on the basis of the process of Step S9. On the other hand, when no instruction to change a recording mode or to select a recorded program to be deleted is obtained within a predetermined period, the request for recording is cancelled, thus returning to the state of Step S1.

In Step S10, when it is judged that the recording is possible, the process goes to Step S7. When it is judged that the recording is not possible, the process returns to Step S8 again. Lastly, in Step S11, the recording and playback processes are monitored, and the registered contents of the history table 13 are updated each time.

According to the foregoing, the communication device 3 of the present embodiment performs authentication as a user for the TV 1 for a mobile communication terminal [potable phone, PHS (Personal Handyphone System) or PDA (Personal Digital Assistant), etc.] which can obtain the TV program information via the Internet 6. The communication device 3 executes each function described in FIG. 3, based on this authentication, instead of the mobile communication terminal 5.

Furthermore, the program video recording apparatus (TV 1 and communication device 3) of the present invention is not limited to the above embodiment, and can be realized by modifications of the configuration and/or operation, and further by extensions of functions on the basis of this embodiment. These will be described below.

First, although the communication device 3 described in the above embodiment is not a telephone which has a subscription contract with a telecommunications carrier (having a subscriber line), it can be used by installing a computer program which can execute the operations of the present invention in an ordinary mobile communication terminal having a subscriber line.

Further, in the above embodiment, the specific site on the Internet 6 is described as a provider for providing TV program information, though, for example, the provider may be an information server, etc. (not shown) of a telecommunications carrier with which the mobile communication terminal 5 has a subscription contract.

Moreover, in the above embodiment, the digital television set is mentioned as the TV 1, and the television set is internally or externally provided with recording means using storage means e.g. an HDD device. However, it may be an analog television set. In this case, for example, the television set is internally or externally provided with a video tape recorder which makes a recording on a recoding medium such as a video tape or the like. Further, the analog television set may be internally or externally provided with a recording means using a storage means, for example, an HDD device, etc. through analog/digital conversion means (not shown).

Additionally, in the above embodiment, the recording reservation operation is carried out based on the displayed TV program information in the state of establishing the communication line to the Internet 6. However, the displayed TV program information may be temporarily stored and after the disconnection of communication line to the Internet 6 the recording reservation operation may be carried out while the stored TV program information is being displayed on the TV 1.

Furthermore, in Step S9 of the above embodiment (see FIG. 6), when no instruction to change a recording mode or to select a recorded program to be deleted is obtained within the predetermined time period, the request for recording is cancelled. In contrast, the program which has the earliest date, has been already played back or the like, may be deleted with higher priority among the recorded program contents in the history table 13, so that the control section 7 secures enough capacity for recording, and then the process may go to Step S7.

Further, in the above embodiment, the history table 13 is provided in the communication device 3, and the contents of the program to be recorded, etc. are registered in the history table 13, but this may be provided as INDEX information in the storage means of the TV 1.

Also, though, in the above embodiment, the communication device 3 is described as a device independent of the TV 1, the communication device 3 of the present invention includes such a case that the configuration of the TV 1 serves for the corresponding configuration of the communication device 3 (see FIG. 2). Examples of the case include a case where a control section (not shown) of the TV 1 performs the operations of the control section 7 of the communication device 3, and a transmission/reception section (not shown) of the TV 1 performs the operations of the transmission/reception section 9 of the communication device 3.

Possible operations to be executed for this case will be described. For example, when the TV 1 has a subscriber line, the transmission/reception section establishes a communication line to a designated site on an information network such as the Internet 6 and the TV 1 displays TV program information. The control section instructs a recording reservation for a program in accordance with program designation from the program information by a remote controller for recording, e.g. the mobile communication terminal 5.

Also, the communication device of the present invention can be realized by a computer program which enables this communication device to function. This computer program may be stored on a computer-readable recording medium, for example a CD-ROM, etc.

The recording medium storing computer program which executes the operations of the communication device 3 may be the ROM 15 itself shown in FIG. 2. Alternatively, a computer program reading device (not shown) e.g. a CD-ROM driver is provided as an external storage device, and the recording medium may also be a CD-ROM or the like which is readable when inserted thereinto. Further, the above recording medium may be a magnetic tape, a cassette tape, a floppy disc®, a hard disc, MO/MD/DVD etc., or a semiconductor memory.

### INDUSTRIAL APPLICABILITY

According to the present invention, program recording can be carried out by directly using a TV program schedule obtained from information networks such as the Internet. Further, it is possible to perform operations in accordance with contents displayed on a TV set by a mobile communication terminal, and thus a user can accomplish a series of processing relating to program recording reservation with easy operations.

1. A program video recording apparatus comprising:
line-establishing means for establishing a communication line with an information provider;
display means for displaying program information provided by the information provider; and
instruction means for instructing a recording reservation for a program in accordance with program designation from the program information displayed on the display means.

2. The program video recording apparatus according to claim 1, further comprising
receiving means for receiving specific information pertinent to a subscriber line,
wherein the line-establishing means establishes the communication line with the information provider based on the specific information received by the receiving means.

3. A computer program allowing a computer to function as a program video recording apparatus, said program video recording apparatus comprising:
line-establishing means for establishing a communication line with an information provider;
display means for displaying program information provided by the information provider; and
instruction means for instructing a recording reservation for a program in accordance with program designation from the program information displayed on the display means.

4. A computer-readable recording medium having a computer program recorded therein, wherein the program causes a computer to function as a program video recording apparatus, said program video recording apparatus comprising:
line-establishing means for establishing a communication line with an information provider;
display means for displaying program information provided by the information provider; and
instruction means for instructing a recording reservation for a program in accordance with program designation from the program information displayed on the display means.
